(19) United States
(12) Patent Application Publication
(10) Pub. No.: US 2015/0019345 A1
(43) Pub. Date: Jan. 15, 2015

(54) INFORMATION PROVISION DEVICE

(71) Applicant: Rakuten, Inc., Shinagawa-ku, Tokyo (JP)

(72) Inventor: Soh Masuko, Shinagawa-ku (JP)

(73) Assignee: Rakuten, Inc., Shinagawa-ku, Tokyo (JP)

(21) Appl. No.: 14/388,976

(22) PCT Filed: Oct. 16, 2012
(86) PCT No.: PCT/JP2012/076718

§ 371 Date: Sep. 29, 2014

(30) Foreign Application Priority Data
Mar. 30, 2012 (JP) 2012-079826

(51) Int. Cl. G06Q 30/02; G06K 9/62; G06F 17/30; G06K 9/46

(52) U.S. Cl. CPC G06Q 30/0269; G06K 9/4604; G06K 9/6202; G06F 17/30244
USPC 705/14.66

(57) ABSTRACT

An information provision device includes a reception unit that receives a display request for a product from a terminal of a user; a body-information acquisition unit that acquires physical characteristics of the user; a search unit that extracts, from a content storage unit that stores therein product content including information on physical characteristics, content that is related to the product indicated by the display request and indicates a state in which the product is worn by a model having physical characteristics that are the same as or similar to the physical characteristics of the user; and a transmission unit that transmits the content extracted by the search unit to the terminal.

### TECHNICAL FIELD

One embodiment of the present invention relates to a device, a method, and a program for providing information useful for users browsing for products, and also a computer-readable recording medium for recording the program.

### BACKGROUND ART

Conventionally, techniques for providing users with content such as texts or images related to products to promote the purchase of the products have been known. For example, Patent Literature 1 discloses a method for, in selling clothing such as work clothes on the internet, displaying an image of a product selected or an image of a related product such as a product for a different season on a product order screen.

### CITATION LIST

### Patent Literature

[Patent Literature 1] Japanese Patent Application Laid-Open Publication No. 2010-286972

### SUMMARY OF INVENTION

### Technical Problem

In a specific field of products such as accessories, even the same product gives much different impressions depending on physical characteristics of users when the product is used. However, in the method described in Patent Literature 1, only an image of a product and images of related products thereof are merely displayed, so that an impression when a user uses the product cannot be presented and purchase motivation of the user cannot be sufficiently increased in some cases. Even if an image indicating a state in which the product is used is presented to the user, when physical characteristics, such as a body shape and a race, of a model using the product who is the object in the image are different from the physical characteristics of the user, it is difficult for the user to picture how the user herself/himself looks when using the product.

Accordingly, providing such content that can present the impression when the user uses the product is demanded.

### Solution to Problem

An information provision device according to one embodiment of the present invention includes a reception unit that receives a display request for a product from a terminal of a user; a body-information acquisition unit that acquires physical characteristics of the user; a search unit that extracts, from a content storage unit that stores therein product content including information on physical characteristics, content that is related to the product indicated by the display request and indicates a state in which the product is worn by a model having physical characteristics that are the same as or similar to the physical characteristics of the user; and a transmission unit that transmits the content extracted by the search unit to the terminal.

An information provision method according to one embodiment of the present invention includes a reception step of receiving a display request for a product from a terminal of a user; a body-information acquisition step of acquiring physical characteristics of the user; a search step of extracting, from a content storage unit that stores therein product content including information on physical characteristics, content that is related to the product indicated by the display request and indicates a state in which the product is worn by a model having physical characteristics that are the same as or similar to the physical characteristics of the user; and a transmission step of transmitting the content extracted at the search step to the terminal.

An information provision program according to one embodiment of the present invention causes a computer to function as a reception unit that receives a display request for a product from a terminal of a user; a body-information acquisition unit that acquires physical characteristics of the user; a search unit that extracts, from a content storage unit that stores therein product content including information on physical characteristics, content that is related to the product indicated by the display request and indicates a state in which the product is worn by a model having physical characteristics that are the same as or similar to the physical characteristics of the user; and a transmission unit that transmits the content extracted by the search unit to the terminal.

A computer-readable recording medium for recording an information provision program according to one embodiment of the present invention records an information provision program that causes a computer to function as a reception unit that receives a display request for a product from a terminal of a user; a body-information acquisition unit that acquires physical characteristics of the user; a search unit that extracts, from a content storage unit that stores therein product content including information on physical characteristics, content that is related to the product indicated by the display request and indicates a state in which the product is worn by a model having physical characteristics that are the same as or similar to the physical characteristics of the user; and a transmission unit that transmits the content extracted by the search unit to the terminal.

In these embodiments, the content that is related to the product indicated by the display request and indicates a state in which the product is worn by a model having physical characteristics that are the same as or similar to the physical characteristics of the user, is extracted from the content storage unit. This content is transmitted to the terminal. In this manner, the content indicating a state in which the product is worn by a model having physical characteristics that are the same as or similar to the physical characteristics of the user is transmitted to the terminal, whereby an impression when the user wears the product can be presented to the user, so that purchase motivation of the user can be increased.

In the information provision device according to another embodiment, the body-information acquisition unit may acquire the physical characteristics of the user by referring to a purchase-history storage unit that stores therein size of a product that the user has ever purchased.

In this case, because the physical characteristics of the user can be acquired from the size of the product that the user purchased in the past, the user can save the effort of registering his/her own physical characteristics in advance.

In the information provision device according to still another embodiment, the content storage unit may store therein size of the product worn by the model as the physical characteristics of the model, and the search unit may extract content indicating a product whose size is the same as the size of the product that the user has ever purchased.

In this case, because the model wearing the product in the same size is expected to have physical characteristics similar to those of the user, the content including the product whose size is the same as the size of the product that the user purchased in the past is transmitted to the user terminal, whereby the impression when the user uses the product can be presented to the user, so that purchase motivation of the user can be increased.

In the information provision device according to still another embodiment, the content storage unit may store therein content that was posted by other user who is different from the user.

In this case, the content that was posted by the other user can be used as content to be transmitted to the user, and thus an administrator can save the effort of registering the content in advance.

In the information provision device according to still another embodiment, the content storage unit may store therein content that was posted on an external internet site by the other user.

In this case, content that was posted by a person using the external internet site can be used as content to be transmitted to the user, and thus the administrator can save the effort of registering the content in advance.

The information provision device may further include a reward giving unit that gives a certain reward to the other user when a user who has viewed the content that was posted by the other user purchases the product.

In this case, the certain reward is given to the other user, which can encourage the other user to actively post an image of the product.

In the information provision device according to still another embodiment, the content may be text data indicating a comment made by the other user on the product.

In this case, comments that are made by the other user, for example, and are information useful for a user to purchase the product can be transmitted to the user.

In the information provision device according to still another embodiment, the content may be an image showing a scene in which the model wears the product.

In this case, the image showing a scene in which the model wears the product can present an impression when a user wears the product to the user, so that purchase motivation of the user can be increased.

The information provision device according to still another embodiment may further include a first determination unit that determines whether the image posted by the other user is a wearing-scene image showing the scene in which the model wears the product and, if the first determination unit determines that the image posted by the other user is not the wearing-scene image, the transmission unit may determine not to transmit the image to the terminal.

In this case, only the image showing the scene in which the model wears the product, which is information useful for the user to purchase the product, can be transmitted to the user.

The information provision device according to still another embodiment may further include a second determination unit that determines whether feature points of a reference image showing the product exist in the image posted by the other user at a certain proportion or more and also the feature points of the reference image contained in the image posted are dispersed within a certain area in the image posted and, if the second determination unit determines that the feature points do not exist in the image posted by the other user at the certain proportion or more or if the second determination unit determines that the feature points are not dispersed within the certain area in the image posted, the transmission unit may determine not to transmit the image to the terminal.

In this case, only the image showing the whole of the product, which is information useful for the user to purchase the product, can be transmitted to the user.

In the information provision device according to still another embodiment, when the content that is related to the product indicated by the display request and includes physical characteristics that are the same as or similar to the physical characteristics of the user does not exist, the search unit may extract default content that is set for the product.

In this case, even when the content that corresponds to the physical characteristics of the user cannot be extracted, content related to the product can be presented to the user.

The information provision device according to still another embodiment may further include an aggregate unit that acquires, based on a purchase history of products purchased by a specific user, aggregate information in which sizes of the products purchased are aggregated for each physical characteristic, and an aggregate-information search unit that presents information on size of the product to the user based on the physical information of the user and the aggregate information acquired by the aggregate unit.

In this case, because the size of the product corresponding to the physical characteristics of the user is presented to the user based on the purchase history of the specific user, suitable size of the product can be recommended to the user.

The information provision device according to still another embodiment may further include an access-history acquisition unit that refers to an access-history storage unit that stores therein an access history indicating a purchase history or a browsing history of a product to identify a product that the user has ever purchased or viewed, and the search unit may extract from the content storage unit content that corresponds to both of the product indicated by the display request and the physical characteristics of the user and corresponds to the product identified by the access-history acquisition unit.

The product that the user of the terminal purchased or viewed in the past is assumed to be a product in which the user is interested. Accordingly, by presenting the user with the content corresponding to the product identified by the access-history acquisition unit, an impression when products in which the user is interested are combined can be presented, so that purchase motivation of the user can be increased.

### Advantageous Effects of Invention

According to one aspect of the present invention, purchase motivation of a user can be increased.

### BRIEF DESCRIPTION OF DRAWINGS

FIG. 1 is a diagram illustrating a whole structure of a system including an information provision server according to a first embodiment.

FIG. 2 is a block diagram illustrating a functional structure of the information provision server according to the first embodiment.

FIG. 3 is a diagram illustrating a hardware structure of the information provision server according to the first embodiment.

FIG. 4 is a diagram illustrating an example of user information.

FIG. 5 is a diagram illustrating an example of content information.

FIG. 6 is a flowchart illustrating an information provision method performed by the information provision server according to the first embodiment.

FIG. 7 is a diagram illustrating a structure of an information provision program according to the first embodiment.

FIG. 8 is a block diagram illustrating a functional structure of an information provision server according to a second embodiment.

FIG. 9 is a diagram illustrating an example of purchase history information.

FIGS. 10A to 10C are examples of tables indicating correspondence between sizes of products and physical characteristics of users.

FIG. 11 is one example of tables indicating correspondence between size notations of products and unified size notations.

FIG. 12 is a diagram illustrating another example of the content information.

FIG. 13 is a block diagram illustrating a functional structure of an information provision server according to a third embodiment.

FIG. 14 is a diagram illustrating an example of a comment of a user.

FIG. 15 is a diagram illustrating an example of comment information.

FIG. 16 is a block diagram illustrating a functional structure of an information provision server according to a fourth embodiment.

FIG. 17 is a block diagram illustrating a functional structure of an information provision server according to a fifth embodiment.

FIG. 18 is a block diagram illustrating a functional structure of an information provision server according to a sixth embodiment.

FIG. 19 is a diagram illustrating an example of aggregate information.

FIG. 20 is a block diagram illustrating a functional structure of an information provision server according to a seventh embodiment.

FIG. 21 is a diagram illustrating another example of the content information.

### DESCRIPTION OF EMBODIMENTS

Embodiments of the present invention will be described below in detail with reference to the attached drawings. The same reference signs are given to the same or similar elements in description of the drawings, and duplicate explanations are omitted.

### First Embodiment

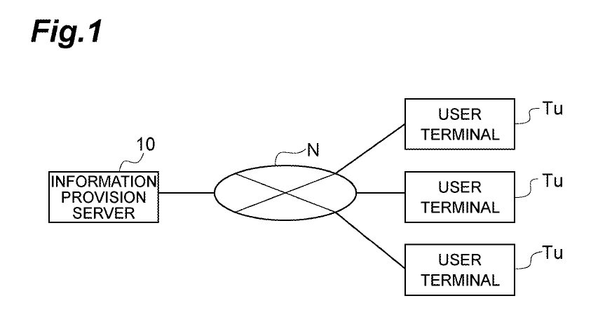

Functions and a structure of an information provision server (information provision device) 10 according to a first embodiment will now be described with reference to FIGS. 1 to 5. The information provision server 10 is a computer system that provides a user with content related to a product sold at an online shopping site, for the purpose of encouraging the user to purchase the product. Examples of the content include a still image or a moving image showing a scene in which the product is actually used, and text data such as a comment of another user on the product, but types of the content are not limited to these. The following describes a mode in which the information provision server 10 provides users with, as the content, an image showing a scene in which a product is actually used. As depicted in FIG. 1, the information provision server 10 is connected to user terminals Tu via a communication network N.

The user terminals Tu each are a terminal of a person (user) who views content information and the content related to the product and possibly purchases the product referring to the information.

In the present embodiment, it is assumed that the two or more user terminals Tu exist, but the number of the user terminals Tu are not limited. The type of the user terminals Tu is not limited, either. For example, the user terminals Tu may be personal computers, personal digital assistants (PDA), or mobile phones.

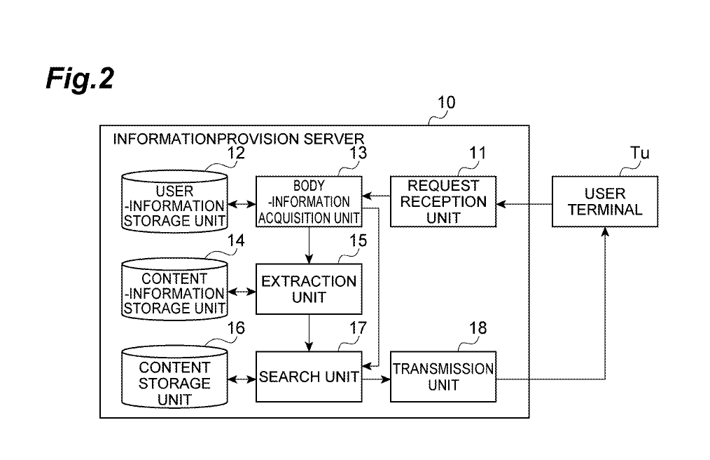

As depicted in FIG. 2, the information provision server 10 includes as functional components a request reception unit (reception unit) 11, a user-information storage unit 12, a body-information acquisition unit 13, a content-information storage unit 14, an extraction unit 15, a content storage unit 16, a search unit 17, and a transmission unit 18. The content-information storage unit 14 and the content storage unit 16 correspond to the content storage unit in the claims.

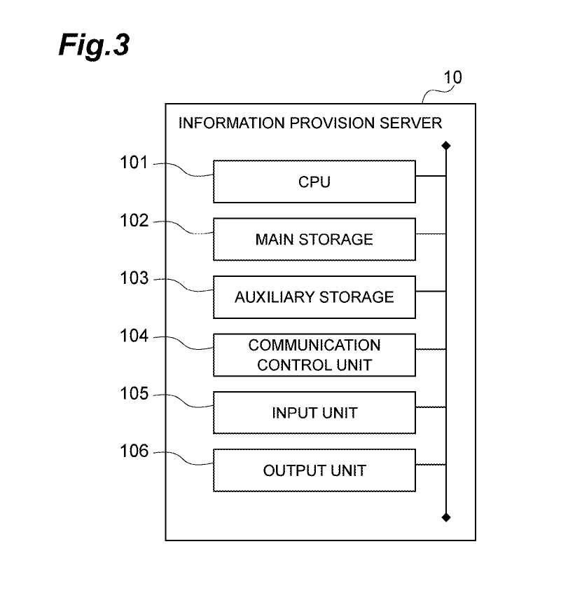

As depicted in FIG. 3, this information provision server 10 includes a CPU 101 for executing an operating system and an application program, for example, a main storage 102 including a ROM and a RAM, an auxiliary storage 103 including a hard disk, a communication control unit 104 including a network card, an input unit 105 such as a keyboard and a mouse, and an output unit 106 such as a monitor. Each function depicted in FIG. 2 is implemented by loading certain software into the CPU 101 and the main storage 102, causing the communication control unit 104 and other components, the input unit 105, and the output unit 106, for example, to operate under the control of the CPU 101, and reading and writing data in the main storage 102 and/or the auxiliary storage 103. Data or a database required for the processing is stored in the main storage 102 and/or the auxiliary storage 103.

In FIG. 3, the information provision server 10 seems to be structured with one computer, but the functions of the information provision server 10 may be distributed into a plurality of computers. For example, the information provision server 10 may include a computer having a database function and a computer having the other functions.

The request reception unit 11 receives a display request for content related to a product from a user terminal Tu. This display request includes a product ID that is an identifier for identifying a product displaying of which is requested by a user and a user ID that is an identifier for identifying the user. The request reception unit 11 outputs the display request received from the user terminal Tu to the body-information acquisition unit 13.

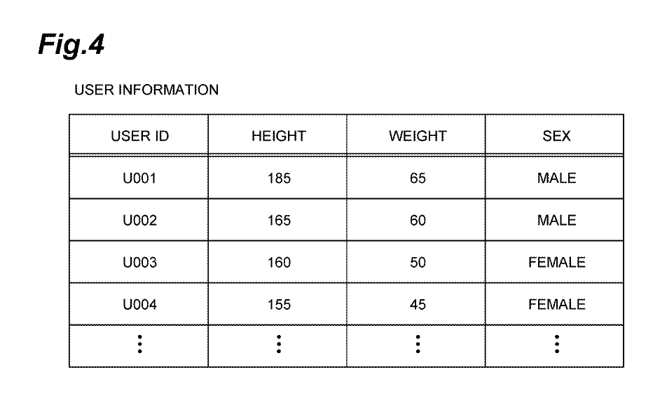

The user-information storage unit 12 stores therein user information on a user. The user information includes a user ID and user body information indicating physical characteristics of the user. In the example depicted in FIG. 4, height, weight, and sex of users correspond to the user body information. These pieces of the user body information are registered in advance by a user of each user terminal Tu. The user body information herein may include user's measurements such as chest circumference, waist circumference, and hip circumference and information such as age, skin color, and race in addition to height, weight, and sex.

The body-information acquisition unit 13 acquires the user body information. When having received an input of a display request from the request reception unit 11, the body-information acquisition unit 13 acquires user body information corresponding to the user ID included in the display request from the user-information storage unit 12. The body-information acquisition unit 13 outputs the user body information thus acquired to the search unit 17. The body-information acquisition unit 13 also outputs the display request to the extraction unit 15.

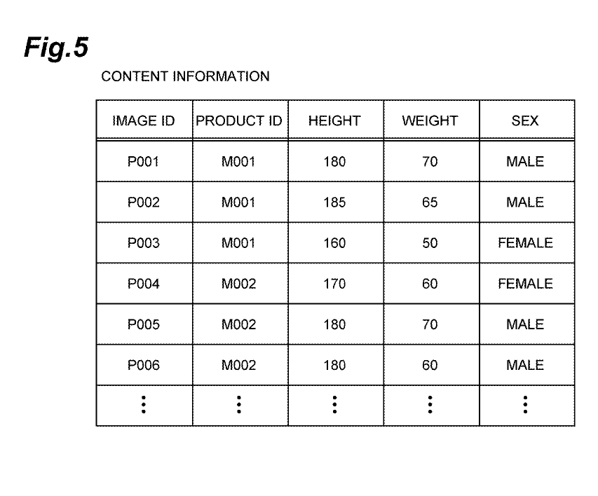

The content-information storage unit 14 stores therein content information on product content. As depicted in FIG. 5, the content information includes an image ID that is an identifier for identifying an image, a product ID, and height, weight, and sex of a model (user) shown in the image. The model herein is a person who is using a product as an object in an image showing a scene in which the product is actually used. For example, when a product to be sold is a garment, a person who is shown in a state of wearing this garment in an image is a model. In this example, height, weight, and sex of the model are pieces of model body information indicating physical characteristics of the model. These pieces of the model body information are registered in advance by an administrator of the information provision server 10. The model body information may include model's measurements such as chest circumference, waist circumference, and hip circumference, and information such as age, skin color, and race in addition to the above-described items.

The extraction unit 15 extracts a piece of content information corresponding to a product ID included in a display request from the content-information storage unit 14. Explained with the example of the content information depicted in FIG. 5, the extraction unit 15 extracts pieces of content information for three records in which the image IDs are “P001”, “P002”, and “P003” from the content-information storage unit 14 when the product ID included in the display request is “M001”. The extraction unit 15 outputs these pieces of content information thus extracted to the search unit 17.

The content storage unit 16 stores therein an image ID and image data associated with each other. The image data is data indicating an image showing a scene in which a model is actually using a product. The content information may include the image data and, in this case, the content storage unit 16 can be omitted.

The search unit 17 searches a piece of content information corresponding to the user body information from the pieces of content information extracted by the extraction unit 15, and extracts an image indicated by the image ID of the piece of content information thus searched, from the content storage unit 16. The piece of content information corresponding to the user body information is a piece of content information which includes model body information that is similar to the user body information. With reference to the examples of the user information depicted in FIG. 4 and the content information depicted in FIG. 5, an example of image extraction performed by the search unit 17 will be described below.

It is assumed that the display request received from the user terminal Tu includes a user ID “U001” and the product ID “M001”. In this case, as user body information corresponding to the user ID “U001”, the height “185 (cm)” and the weight “65 (kg)” are output from the body-information acquisition unit 13 to the search unit 17. Pieces of content information for three records corresponding to the product ID “M001” (the pieces of content information the image IDs of which are “P001”, “P002”, and “P003”) are also output from the extraction unit 15 to the search unit 17.

Among the three pieces of content information input by the extraction unit 15, the search unit 17 extracts pieces of content information that include model body information in which the difference in height from the user is within a certain range. Subsequently, among the pieces of content information thus extracted, the search unit 17 extracts a piece of content information that includes model body information in which the weight is the closest to that of the user body information. For example, assuming that the certain range for height is five centimeters, the search unit 17 extracts two pieces of content information the image IDs of which are “P001” and “P002”, in which the difference from the height “185 (cm)” of the user is within five centimeters. Subsequently, the search unit 17 extracts a piece of content information the image ID of which is “P002”, which corresponds to the model body information in which the weight is the closest to the weight “65 (kg)” of the user. The search unit 17 then extracts an image associated with the image ID “P002” from the content storage unit 16.

The search unit 17 outputs the image thus extracted to the transmission unit 18. If the search unit 17 extracts a plurality of images, the search unit 17 may transmit the images to the transmission unit 18, or may transmit any one of the images to the transmission unit 18. If a piece of content information in which model body information that is similar to the user body information does not exist, the search unit 17 may output a default image that is set in advance for each product to the transmission unit 18. The default image is, for example, an image showing a scene in which a model in an average body shape is using a product.

The above-described method for content extraction performed by the search unit 17 is one example, and a criterion for determining that the user body information is similar to the model body information may be optionally determined. For example, the search unit 17 may use body information other than the height and weight of the user to extract content information. For example, the search unit 17 may use the same sex or race as a criterion for extracting content information.

The transmission unit 18 transmits the image searched by the search unit 17 to the user terminal Tu. Thus, an image showing a scene in which a model the physical characteristics of which are similar to those of a user is using a product specified by the user is displayed on the user terminal Tu.

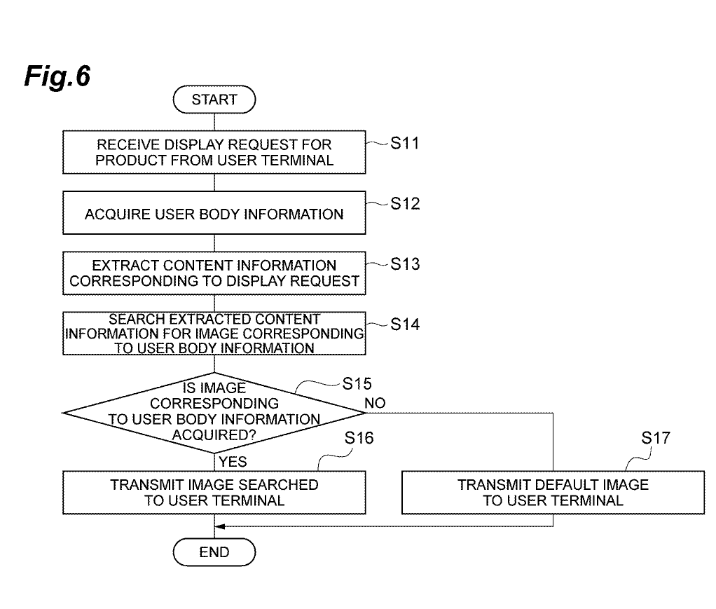

Operation of the information provision server 10 will be described and also an information provision method according to the present embodiment will be described below with reference to FIG. 6.

Content corresponding to the user body information is provided to the user by performing processes as depicted in FIG. 6. To begin with, the request reception unit 11 receives a display request from a user terminal Tu (step S11, reception step). This display request includes a user ID and a product ID.

Next, the body-information acquisition unit 13 acquires user body information corresponding to the user ID from the user-information storage unit 12 (step S12, body-information acquisition step). Subsequently, the extraction unit 15 extracts pieces of content information corresponding to the product ID from the content-information storage unit 14 (step S13, extraction step).

Subsequently, from the pieces of content information thus extracted, the search unit 17 searches a piece of content that corresponds to the user body information acquired (step S14, search step). Specifically, the search unit 17 searches a piece of content information that includes model body information that is similar to the user body information, and extracts an image corresponding to this piece of content information.

If an image corresponding to the user body information is acquired (YES at step S15), the transmission unit 18 transmits the image to the user terminal Tu (step S16, transmission step). If such an image does not exist, the transmission unit 18 transmits a default image of the product that is specified by the user to the user terminal Tu (step S17, transmission step).

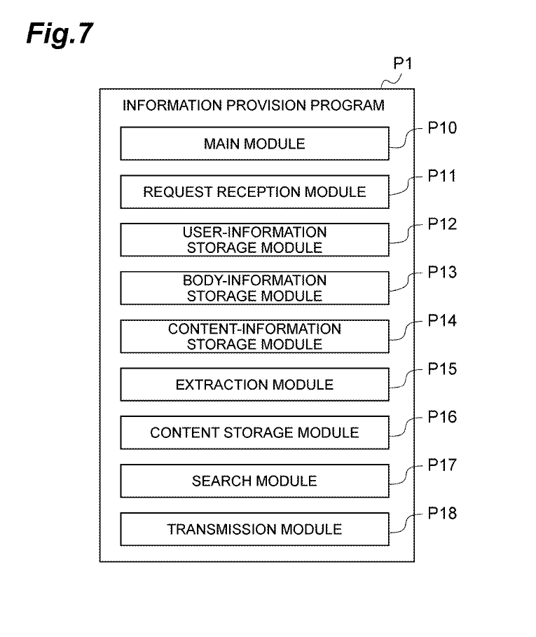

An information provision program for causing a computer to function as the information provision server 10 will be described below with reference to FIG. 7.

This information provision program P1 includes a main module P10, a request reception module P11, a user-information storage module P12, a body-information acquisition module P13, a content-information storage module P14, an extraction module P15, a content storage module P16, a search module P17, and a transmission module P18.

The main module P10 is a portion for controlling the information providing function in an integrated manner. Functions that are implemented by executing the request reception module P11, the user-information storage module P12, the body-information acquisition module P13, the content-information storage module P14, the extraction module P15, the content storage module P16, the search module P17, and the transmission module P18 are the same as the functions of the request reception unit 11, the user-information storage unit 12, the body-information acquisition unit 13, the content-information storage unit 14, the extraction unit 15, the content storage unit 16, the search unit 17, and the transmission unit 18, respectively.

The information provision program P1 is provided in a state of being recorded in, for example, a recording medium such as CD-ROM or DVD-ROM, or a semiconductor memory. The information provision program P1 may be provided as a computer data signal that is superimposed on a carrier wave via a communication network.

As described above, according to the present embodiment, content (image) corresponding to a product indicated by the display request and physical characteristics of the user is extracted by referring to the content-information storage unit 14 and the content storage unit 16. This content is then transmitted to the user terminal Tu. In this manner, the content corresponding to the physical characteristics of the user is transmitted to the user terminal Tu, whereby the impression when the user uses the product can be presented to the user, so that purchase motivation of the user can be increased.

In an internet shopping site, if a user cannot have an impression when using a product, the user searches around within the site looking for various images, which may increase the load on the server. In contrast, according to the present embodiment, content including physical characteristics that are the same as or similar to the physical characteristics of the user is transmitted to the user terminal Tu, whereby an impression when the user uses the product can be presented to the user. This can reduce the necessity for the user to search around within the site, thereby suppressing the increase of the load on the server.

According to the present embodiment, when content (image) corresponding to the product indicated by the display request and the physical characteristics of the user does not exist, a default image is transmitted to the user terminal Tu. Thus, even when content corresponding to the physical characteristics of the user cannot be extracted, content related to the product can be presented to the user.

### Second Embodiment

An information provision server 10A according to a second embodiment will be described hereinafter. This information provision server 10A differs from the information provision server 10 according to the first embodiment in that user body information is acquired based on a product purchase history of the user. Explanations of matters that are the same as or similar to those of the first embodiment are omitted below.

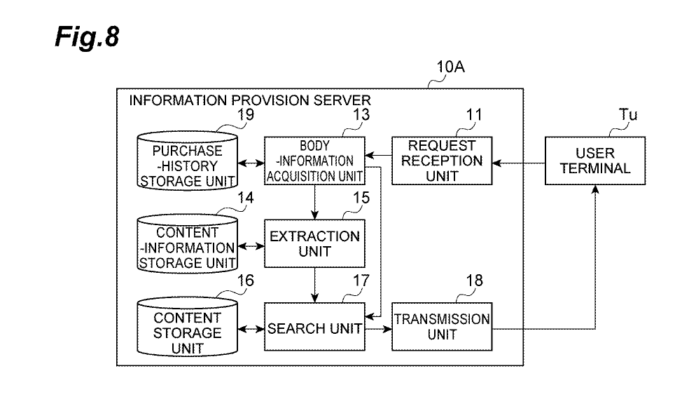

As depicted in FIG. 8, the information provision server 10A includes a purchase-history storage unit 19 instead of the user-information storage unit 12. The other components are the same as those of the information provision server 10.

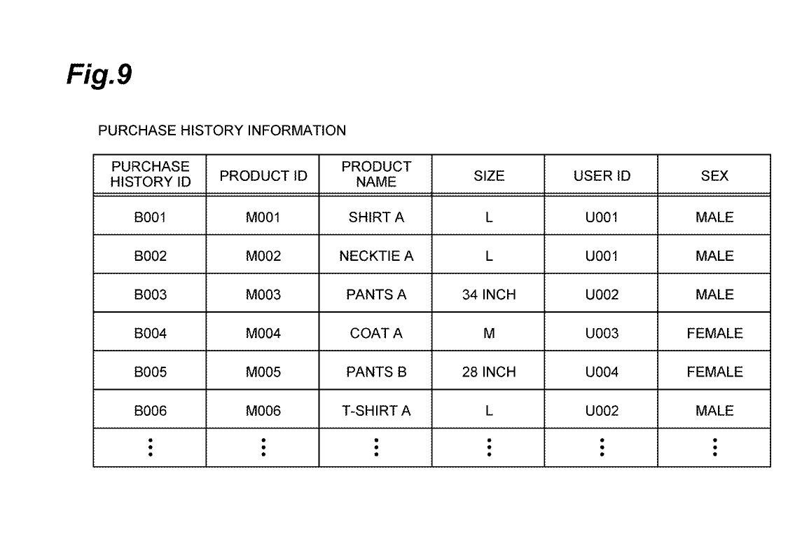

The purchase-history storage unit 19 stores therein purchase history information indicating product purchase histories of users. The purchase history information includes information indicating products that the users purchased in the past and the sizes thereof. As depicted in FIG. 9, the purchase history information includes a purchase history ID that is an identifier for identifying a purchase history, information (product ID, product name, and size) on a purchased product, and information (user ID and sex) on a user who purchased the product. The information included in the purchase history information is not limited to the example in FIG. 9, and may include, for example, pieces of information such as a product category, a manufacturer of a product, and a producing country.

The body-information acquisition unit 13 acquires user body information on the basis of the purchase history information in the purchase-history storage unit 19. When having received a display request from the request reception unit 11, the body-information acquisition unit 13 extracts a piece of purchase history information that corresponds to the user ID included in the display request from the purchase-history storage unit 19 to acquire the size of a product that the user purchased in the past. The body-information acquisition unit 13 acquires user body information from the size of the product thus acquired.

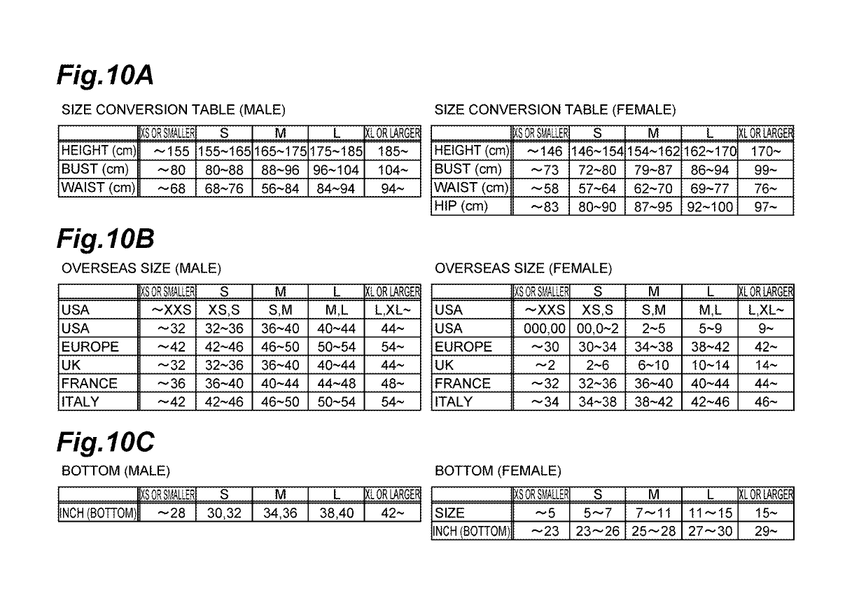

Specifically, the body-information acquisition unit 13 uses correspondence tables as depicted in FIG. 10A to estimate measurements of the user from the size of the purchased product. For example, when the size of the product is “L” size and the purchasing user is a male, by referring to the table titled “Size Conversion Table (Male)” depicted in FIG. 10, the measurements of the user are estimated to be 175 to 185 centimeters in height, 96 to 104 in bust, and 84 to 94 in waist. The body-information acquisition unit 13 acquires the measurements of the user thus estimated as the user body information.

When size notations vary by product, the body-information acquisition unit 13 may convert a size notation of a product into a unified size notation using the correspondence table and then estimate the measurements of the user. For example, when the size of pants of the male is “38 inches”, the body-information acquisition unit 13 may convert the size into “L” size, referring to the table titled “Bottom (Male)” in FIG. 10C, and then estimate the measurements of the user referring to the table titled “Size Conversion Table (Male)” in FIG. 10A.

Even when size notations of products are the same, there is a case in which actual sizes vary depending on manufacturers or producing countries. In such a case, the body-information acquisition unit 13 may convert the sizes so that the actual sizes are the same, using a correspondence table as depicted in FIG. 10B, and then estimate the measurements of the user. For example, the body-information acquisition unit 13 may convert the “XS” size used for a US-made product into the “S” size, referring to the table titled “Overseas Size (Male)” in FIG. 10B, and then estimate the measurements of the user, referring to the table titled “Size Conversion Table (Male)” depicted in FIG. 10. In this case, the purchase history information may include, for example, information indicating on which country the size notation is based. Furthermore, the purchase history information may include a brand ID indicating a brand of a product, and the brand ID may be associated with information indicating on which country this brand ID is based.

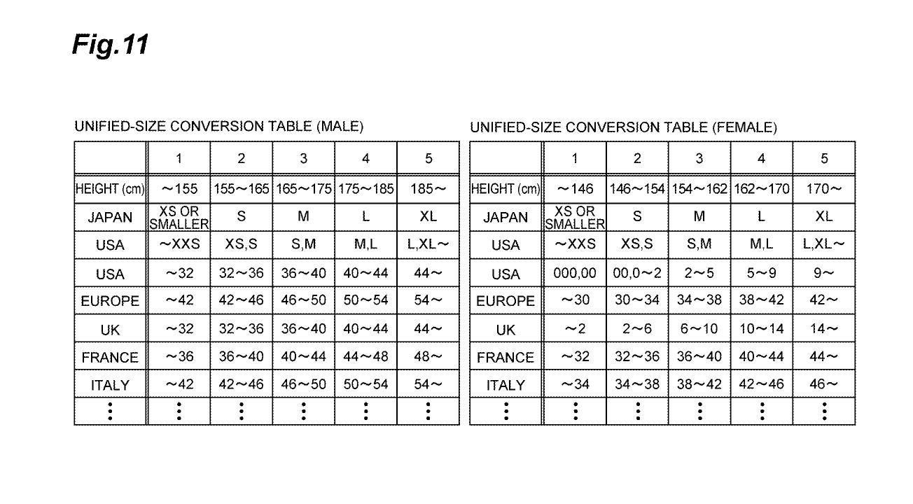

When a purchase history is added to the purchase history information, the overseas size or the size in each brand may be converted into a unified size standard to be stored as the size in the purchase history information. For example, the information provision server 10A may include a correspondence table as depicted in FIG. 11. Based on this corresponding table, in a case of a product for female, the information provision server 10A may store therein as the purchase history information the unified size 1 for all of heights lower than 146 centimeters, XS or smaller in Japanese size notation, XXS or smaller in US size notation, 000,00 in US size notation, smaller than 30 in European size notation, smaller than 2 in UK size notation, smaller than 32 in French size notation, and smaller than 34 in Italian size notation. In this case, because the unified size notation into which these various sizes are converted in advance is stored, the necessity of performing a size conversion process every time a display request for a product is received is eliminated, whereby the computational load on the information provision server 10A can be reduced.

The search unit 17 extracts from the content storage unit 16 an image corresponding to the user body information that has been acquired based on the purchase history information. With reference to the examples of the purchase history information depicted in FIG. 9 and the content information depicted in FIG. 5, an example of image extraction performed by the search unit 17 will be described below.

It is assumed that the display request received from the user terminal Tu includes a user ID “U001” and the product ID “M001”. In this case, pieces of purchase history information for two records in which purchase histories corresponding to the user ID “U001” are “B001” and “B002” are extracted. Thus, the product size of these pieces of purchase history information is “L” and, based on the table titled “Size Conversion Table (Male)” depicted in FIG. 10A, the measurements of the user are estimated to be 175 to 185 centimeters in height, 96 to 104 in bust, and 84 to 94 in waist. The search unit 17 uses the user body information thus estimated. The search unit 17 receives from the extraction unit 15 input of pieces of content information for three records the product ID of which corresponds to “M001” and the image IDs of which are “P001”, “P002”, and “P003”.

Subsequently, among these pieces of content information, the search unit 17 extracts pieces of content information including model body information in which the difference in height from the user is within a certain range. For example, the search unit 17 extracts pieces of content information that include model body information included in the height “175 to 185 centimeters” of the user and the image IDs of which are “P001” and “P002”. The search unit 17 then extracts images associated with the image IDs “P001” and “P002” from the content storage unit 16. Because subsequent processes are the same as those of the first embodiment, detail explanations are omitted.

As described above, according to the present embodiment, because the body-information acquisition unit 13 acquires physical characteristics of a user on the basis of purchase history information of the user, the user can save the effort of registering his/her own physical characteristics in advance. Even if the characteristics of the user were registered in advance, when the registered characteristics are old, body shape of the user may have changed. On this point, according to the present embodiment, the physical characteristics of the user are acquired based on the size of a garment that was purchased after the time of registration of the body information, and accordingly an image of a model having a body shape that is closer to the current body shape of the user can be displayed.

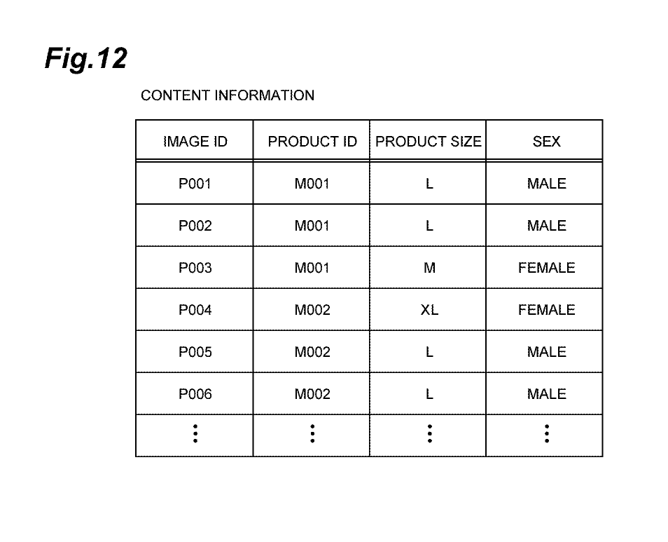

In the present embodiment, the body-information acquisition unit 13 estimates user body information from the size of a past purchased product of the user and the search unit 17 searches an image corresponding to the user body information, but alternatively this image search may be performed in the following manner. For example, as depicted in FIG. 12, it is assumed that the model body information in the content-information storage unit 14 indicates the product size used by the model instead of the height or the weight of the model. In this case, the body-information acquisition unit 13 may output the size of a past purchased product of the user as the user body information to the search unit 17, and the search unit 17 may extract content the content information of which includes the product size that matches the size of the purchased product.

It can be assumed that a model using a product in the same size has physical characteristics that are similar to those of the user. Accordingly, by transmitting to the user the content including a product the size of which is the same as the size of a product that the user purchased in the past, an impression when the user uses the product can be presented to the user, whereby purchase motivation of the user can be increased.

### Third Embodiment

An information provision server 10B according to a third embodiment will be described hereinafter. This information provision server 10B extracts an image that is posted by another user. Explanation of matters that are the same as or similar to those of the first embodiment are omitted below.

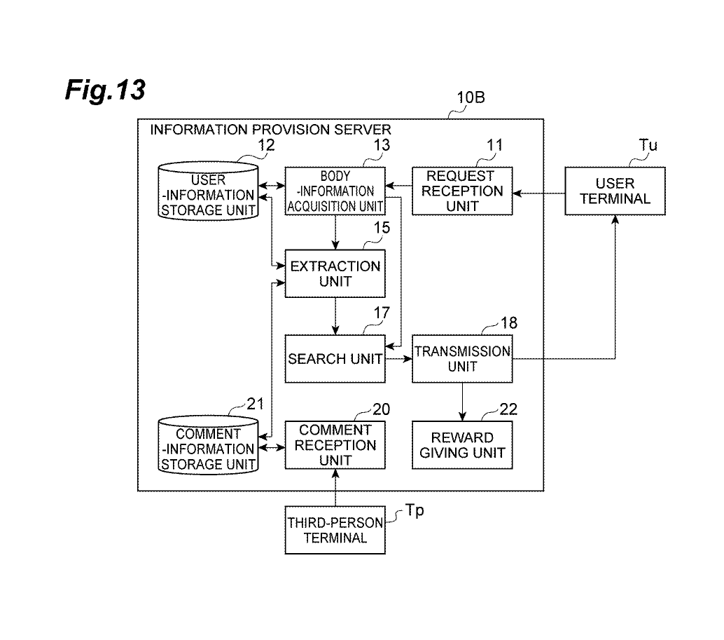

As depicted in FIG. 13, the information provision server 10B further includes a comment reception unit 20, a comment storage unit (content storage unit) 21, and a reward giving unit 22 instead of the content-information storage unit 14 and the content storage unit 16. In the present embodiment, the extraction unit 15 extracts content from the comment storage unit 21. The other components are the same as those of the information provision server 10.

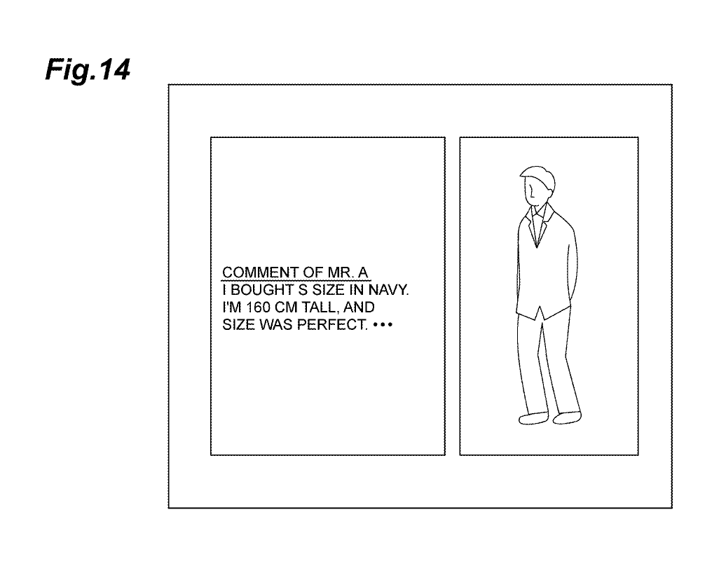

In an online shopping site, as depicted in FIG. 14, functions may be provided by which a user can write a review or a comment on a purchased product and an image can be uploaded together with the review and the comment. The comment reception unit 20 receives an image and text data such as a comment from a user (another user, also referred to as “model user” hereinafter) of a third-person terminal Tp who is different from the user of the user terminal Tu. When having received a comment, for example, from the third-person terminal Tp, the comment reception unit 20 stores comment information including the text data and the image in the comment storage unit 21.

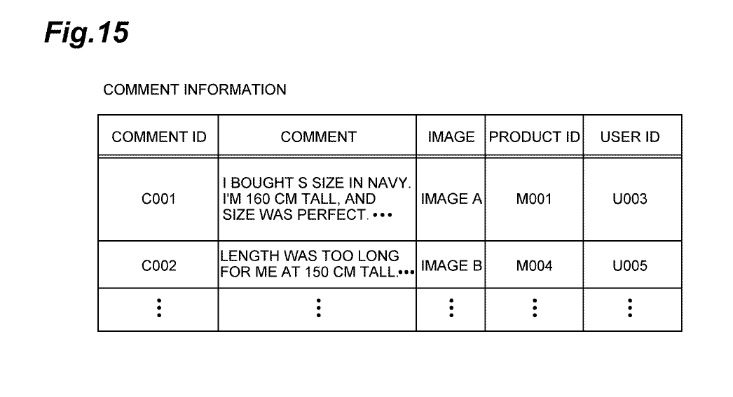

The comment storage unit 21 stores therein the comment information received from the comment reception unit 20. As depicted in FIG. 15, the comment information includes a comment ID that is an identifier for identifying a comment, a comment, an image that is uploaded with the comment, a product ID of a product on which the comment is posted, and a user ID of a user who posted the comment.

The reward giving unit 22 gives a certain reward to a model user when content that was posted by the model user is transmitted to the user terminal Tu. When the content posted by the model user is transmitted to the user terminal Tu, the reward giving unit 22 gives the certain reward to the corresponding model user. Conditions for the reward to be given to the model user are not limited to the case that the content is transmitted to the user terminal Tu, and may include a case that the user of the user terminal Tu purchases a product on the basis of presented content. In this case, the reward giving unit 22 may give the reward when referring to a Web-page browsing history of the user of the user terminal Tu and determining that the user of the user terminal Tu has purchased a product from a Web page including the content posted by the model user.

The extraction unit 15 extracts a piece of comment information corresponding to the product ID included in the display request from the comment storage unit 21. The extraction unit 15 also acquires from the user-information storage unit 12 physical characteristics of a user corresponding to the user ID included in the piece of comment information thus extracted. The extraction unit 15 then outputs the piece of comment information acquired and the physical characteristics of the model user to the search unit 17.

The search unit 17 compares user body information of a searcher input by the body-information acquisition unit 13 with physical characteristics of model users input by the extraction unit 15 to identify a model user whose body shape is close to that of the searcher. The search unit 17 outputs an image indicated in a piece of comment information of the model user thus identified to the transmission unit 18.

An example of such processing performed by the extraction unit 15 and the search unit 17 will be described with reference to the user information depicted in FIG. 4 and the comment information depicted in FIG. 15. It is assumed that the display request received from the user terminal Tu includes a user ID “U004” and a product ID “M001”. In this case, to the extraction unit 15, user body information (height “155 (cm)”, weight “45 (kg)”) corresponding to the user ID is input.

The extraction unit 15 extracts a piece of comment information including the comment ID “C001” corresponding to the product ID “M001” from the comment storage unit 21. Subsequently, the extraction unit 15 acquires from the user-information storage unit 12 physical characteristics (height “160 (cm), weight “50 (kg)”) of a model user corresponding to the user ID “U003” included in the piece of comment information thus extracted. The extraction unit 15 outputs the piece of comment information extracted and the physical characteristics to the search unit 17.

If the difference between the height of the model user extracted and the height included in the user body information received from the body-information acquisition unit 13 is within a certain range, the search unit 17 extracts an image included in the pieces of comment information extracted. For example, when the certain range is five centimeters, the search unit 17 determines that the physical characteristics of the model user and those of the searcher are similar, and outputs the image included in the piece of comment information of the comment ID “C001” to the transmission unit 18.

The transmission unit 18 transmits the image output by the search unit 17 to the user terminal Tu. In this manner, an image posted by a user of a third-person terminal Tp who has physical characteristics similar to those of the user of the user terminal Tu is presented to the user terminal Tu. After transmitting the image to the user terminal Tu, the transmission unit 18 outputs a signal indicating transmission completion to the reward giving unit 22. The reward giving unit 22 then gives the certain reward to the model user of the user ID “U003” who posted the extracted image.

In the above-described example, a user ID of a model user is stored as comment information in the comment storage unit 21, but the comment information does not necessarily have to include the user ID. In some online shopping sites, a user whose user registration has not been made, that is, a user whose user information is not stored in the user-information storage unit 12, may be allowed to write a comment or upload an image. In such a case, the extraction unit 15 may search a comment section in comment information for a description on physical characteristics of a user who wrote a comment, to use the description as body information of a user of a third-person terminal Tp. For example, the extraction unit 15 may search the comment for a keyword indicating physical characteristics such as “cm” or “kg” and, when such a keyword exists, may use the keyword as the body information of the model user. For example, the extraction unit 15 may use the height “160 (cm)” as the physical characteristics of the user of the third-person terminal Tp from the description “ . . . I'm 160 cm tall, and . . . ” in the comment information depicted in FIG. 15.

In the present embodiment, the search unit 17 extracts the image of the model user whose physical characteristics are similar to those of the user of the user terminal Tu from the comment storage unit 33, but alternatively the search unit 17 may extract the comment of the model user whose physical characteristics are similar to those of the user of the user terminal Tu. For example, in the piece of comment information corresponding to the comment ID “C002” in FIG. 15, the comment “ . . . the length was too long for me with a height of 150 cm . . . . ” may be presented to a user with a height of 145 to 155 centimeters. This is because such a comment is useful information for determining the size of a product that the user of the user terminal Tu is going to purchase.

In the information provision server 10B according to the present embodiment, effects can be obtained that are the same or similar to those of the above-described information provision server 10. As described above, according to the present embodiment, the comment storage unit 21 stores therein content that was posted by a person of a third-person terminal Tp who is different from the user of the user terminal Tu. Thus, because the content posted by the user of the third-person terminal Tp can be used as content to be transmitted to the user, the administrator can save the effort of registering the content in advance.

The information provision server 10B presents text data indicating a comment made by the user of the third-person terminal Tp on the product to the user of the user terminal Tu. Accordingly, the comment that is made by a third person and is information useful for the user of the user terminal Tu to purchase the product can be transmitted to the user.

According to the present embodiment, when an image posted by a user is transmitted to the user terminal Tu, the certain reward is given to the user, which can encourage users to actively post products combination images.

### Fourth Embodiment

An information provision server 10C according to a fourth embodiment will be described hereinafter. This information provision server 10C extracts content of a computer system in an external network. Explanations of matters that are the same as or similar to those of the first embodiment are omitted below.

In a system on the internet such as a social networking service (SNS), a function may be provided for a person using the system to write a comment and upload an image on a product. The information provision server 10C searches such an external site for content.

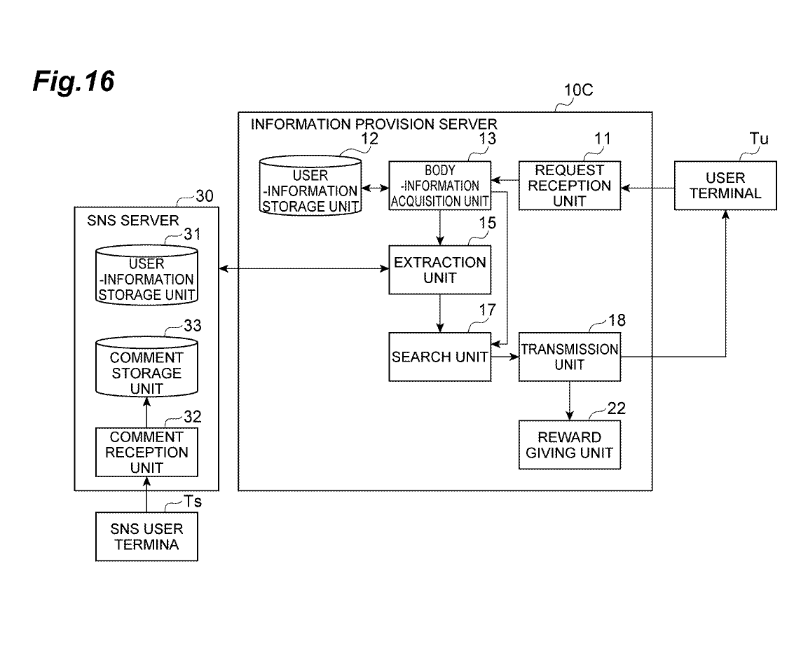

As described in FIG. 16, the information provision server 10C does not include the content-information storage unit 14 or the content storage unit 16, and includes the reward giving unit 22. In the present embodiment, the extraction unit 15 extracts content information from an SNS server 30 that is an external site. The other components are the same as those of the information provision server 10.

The SNS server 30 is one of external sites, and includes a user-information storage unit 31, a comment reception unit 32, and a comment storage unit 33. The user-information storage unit 31 stores therein user information on a user of an SNS. The comment reception unit 32 receives an image and text data such as a comment from a user of an SNS user terminal Ts (hereinafter, also referred to as “SNS user”) who is a person using the SNS server 30. When having received a comment, for example, from the SNS user terminal Ts, the comment reception unit 32 stores comment information including the text data and the image in the comment storage unit 33. The comment storage unit 33 stores therein the comment information input by the comment reception unit 32.

The extraction unit 15 refers to the comment storage unit 33 via the communication network N, and extracts a comment containing a product name that corresponds to a product ID included in a display request and an image that is posted with the comment. The extraction unit 15 outputs the comment and the image thus extracted to the search unit 17. Furthermore, the extraction unit 15 refers to the user-information storage unit 31 of the SNS server 30, extracts information that indicates physical characteristics of an SNS user who wrote the comment extracted, and outputs the information to the search unit 17.

However, there are cases in which a person using the SNS server does not register physical characteristics thereof such as height or weight as user information, or does not open this information to third persons. In such cases, the extraction unit 15 may search a description on the physical characteristics of the SNS user from comments stored in the comment storage unit 33 to use the description as the physical characteristics of the SNS user. For example, the extraction unit 15 may search comments for a keyword indicating physical characteristics such as “cm” or “kg” and, when such a keyword exists, may acquire the keyword as the physical characteristics of the SNS user.

Based on the comment and the image of the SNS user that are output by the extraction unit 15 and the physical characteristics of the user, the search unit 17 extracts an image corresponding to the user body information from the SNS server 30. Specifically, the search unit 17 extracts an image that is uploaded by an SNS user having body information similar to the user body information from the content information output by the extraction unit 15. Specifically, the search unit 17 searches a piece of content information in which the difference between the height of the user of the user terminal Tu and the height of the SNS user is within a certain range, and extracts an image posted by an SNS user included in the content information. The search unit 17 outputs the image thus extracted to the transmission unit 18.

The transmission unit 18 transmits the image thus output by the search unit 17 to the user terminal Tu. In this manner, an image posted by an SNS user who has physical characteristics similar to those of the user of the terminal Tu is presented to the user terminal Tu. After transmitting the image to the user terminal Tu, the transmission unit 18 outputs a signal indicating transmission completion to the reward giving unit 22. The reward giving unit 22 then gives the certain reward to the SNS user who posted the extracted image.

In the above-described embodiment, the image posted by the SNS user whose physical characteristics are similar to those of the user of the user terminal Tu is extracted from the comment storage unit 33, but alternatively the search unit 17 may extract a comment posted by the SNS user whose physical characteristics are similar to those of the user of the user terminal Tu from the comment storage unit 33. This is because such a comment is useful information for determining the size of a product that the user of the user terminal Tu is going to purchase.

The extraction unit 15 only have to extract images of the product indicated by the display request and the product corresponding to the physical characteristics of the user, and how information necessary to extract these images is stored is optional. For example, when a user opens an external site such as a blog using a user ID of the information provision server 10C, the user ID of the information provision server 10C may be stored in the external site. Information that can identify a product, such as a product ID and a product name, may be stored in a storage of the external site in a manner associated with an image.

In the information provision server 10C according to the present embodiment also, effects can be obtained that are the same or similar to those of the above-described information provision server 10. As described above, according to the present embodiment, the search unit 17 searches content posted by a person using the SNS server 30. Thus, because the content posted by the person using the SNS server 30 can be used as content to be transmitted to the user, the administrator can save the effort of registering the content in advance.

The information provision server 10C presents text data indicating a comment made by the SNS user on the product to the user of the user terminal Tu. Accordingly, the comment that is made by a third person and is information useful for the user of the user terminal Tu to purchase the product can be transmitted to the user.

According to the present embodiment, when an image posted by an SNS user is transmitted to the user terminal Tu, the certain reward is given to the SNS user, which can encourage SNS users to actively post product images.

### Fifth Embodiment

An information provision server 10D according to a fifth embodiment will be described hereinafter. This information provision server 10D determines whether an extracted image is content indicating a state of the product being used. Explanations of matters that are the same as or similar to those of the fourth embodiment are omitted below.

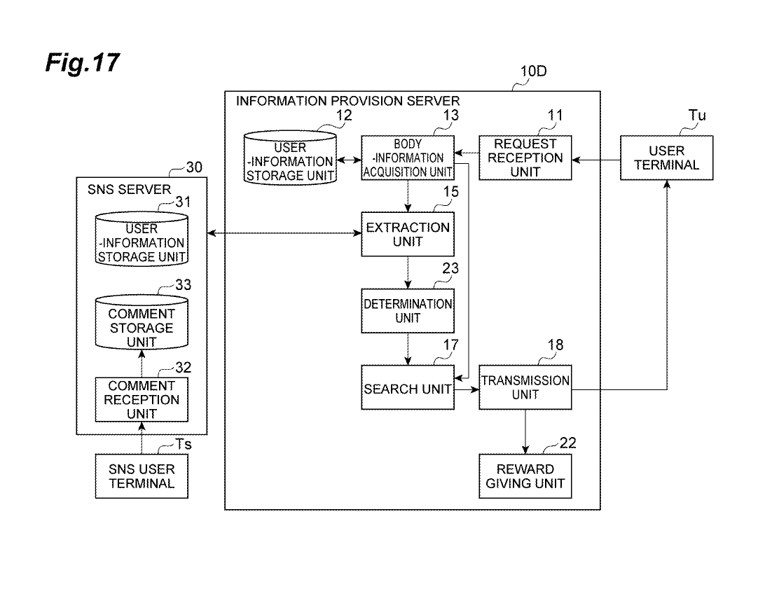

As depicted in FIG. 17, the information provision server 10D according to the present embodiment further includes a determination unit (first determination unit, second determination unit) 23, and content extracted by the search unit 17 is output to the determination unit 23. The other components are the same as those of the information provision server 10C in the fourth embodiment.

The determination unit 23 determines whether an image extracted by the search unit 17 (hereinafter, referred to as “target image” in the present embodiment) is an image showing a scene in which the product is used. Because images stored in the comment storage unit 33 of the SNS server 30 are images that the SNS user can freely upload, some images may not show a scene in which an SNS user uses the product, or may not show the whole of the product. Accordingly, when having determined that the target image is not an image showing a scene in which the target product is used, the determination unit 23 prevents the target image from being transmitted to the transmission unit 18. The following describes a method performed by the determination unit 23 to determine whether the image is an image showing a scene in which the product is used.

The determination unit 23 calculates a feature amount indicating features of the target image when the target image is input by the search unit 17. The determination unit 23 also calculates the feature amount of an image (hereinafter, referred to as “comparative image” in the present embodiment) indicating a scene in which the same product as in the target image stored in a certain storage is used. The determination unit 23 then compares the feature amount of the target image with the feature amount of the comparative image to determine the degree of similarity between both images. If the degree of similarity between both images is within a certain range, the determination unit 23 outputs the target image to the transmission unit 18. If the degree of similarity between both images is not within the certain range, the determination unit 23 discards the target image without outputting it to the transmission unit 18. This can prevent an image that is not an image showing a scene in which the product is used from being transmitted to the user terminal Tu. When discarding the target image, the determination unit 23 may output a default image attached to the product to the transmission unit instead of the target image. This can prevent a situation in which no image is transmitted to the user terminal Tu.

Alternatively, the determination unit 23 may determine whether to transmit the target image to the transmission unit 18 on the basis of a proportion for which an image of the product accounts in the target image. For example, the determination unit 23 sets a plurality of feature points in advance for an image showing each product (hereinafter, referred to as “reference image”) and, based on the number of feature points contained in the target image, determines whether the whole of the product is shown in the target image. In this case, when having determined that the whole of the product is shown in the target image, the determination unit 23 outputs the target image to the transmission unit 18. When having determined that the whole of the product is not shown in the target image, the determination unit 23 discards the target image without outputting it to the transmission unit 18. This can prevent an image in which the whole of the product is not shown from being transmitted to the user terminal Tu. The reference image is preferably an image the background of which is plain.

Furthermore, the determination unit 23 may determine whether feature points of the reference image showing the product exist at a certain proportion or more in an image posted by an SNS user and also the feature points of the reference image contained in the image posted by the SNS user are dispersed in a certain area of the image posted by the SNS user. The certain area herein is an area that is determined, for example, based on a category of a product such as tops or bottoms. This area can be set in the upper part of the image when the product falls under tops, can be set in the lower part of the image when the product falls under bottoms, and can be set in the whole part of the image when the product falls under a one-piece suit. In this case, the comment storage unit 33 is required to store therein categories of products. For example, when the area of the feature points of the reference image contained in the target image is larger than the certain area, the determination unit 23 determines that the feature points are dispersed over the whole of the certain area. If having determined that the target image is an image showing a scene in which the product is worn, the determination unit 23 outputs the target image to the transmission unit 18. If this is not the case, the determination unit 23 discards the target image without outputting it to the transmission unit 18. This can prevent a target image that is not an image showing a scene in which the product is worn from being transmitted.

When the target image does not contain the feature points of the reference image at the certain proportion or more, the target image is more likely to be a magnified image showing part of the product, or picture quality of the target image is more likely to be poor. When the feature points of the target image are not dispersed in the upper part or the lower part of the target image depending on the category of the product, the target image is more likely to be an image that shows the product on a small scale although showing the whole of the product, or to be an image in which the product is not worn. Thus, with the determination unit 23 as described above, an image showing a close-up of part of the product, an image showing the product on a small scale, or an image that is not an image in which the product is worn can be prevented from being transmitted to the user, whereby an image that is more likely to be an image in which a model wears the product and is easily viewable can be selectively transmitted.

Alternatively, the determination unit 23 may use color histogram matching to determine whether the target image is similar to the comparative image. In this case, when the color histogram of the target image is similar to that of the comparative image, the determination unit 23 can determine that the target image is an image in which the product is worn. When color histogram matching is performed, a histogram in which the abscissa indicates a parameter (e.g., gray scale (=RGB/3)) representing a color and the ordinate indicates the number of pixels of a respective image is prepared for each of the target image and the comparative image. When the shape of the histogram of the target image is similar to that of the comparative image, the determination unit 23 determines that the target image is similar to the comparative image. This is because it is expected that the target image is more likely to show the same product as in the comparative image, in the same size, when the shape of the histogram of the target image is similar to that of the comparative image.

The determination unit 23 may extract an image showing the whole of the product or an image that is easily viewable, as described below. To begin with, when a certain number of target images posted by SNS users have accumulated, the determination unit 23 compares the target images with each other to classify them into groups of similar images. As a method for determining whether the images are similar to each other herein, any optional method can be used such as the method based on the number of feature points or the method using color histograms as described above. Subsequently, among the target images, the determination unit 23 excludes images that were not classified into groups each containing a plurality of target images. For example, when ten target images exist, five of the target images belong to a first group, three of the target images belong to a second group, one of the target images belongs to a third group, and the remaining one of the target images belongs to a fourth group, the determination unit 23 excludes the two images belonging to the third group and the fourth group (i.e., each does not belong to a same group together with another target image). By such a determination method, determination can be made without using a comparative image. When a plurality of images are extracted, the determination unit 23 outputs the target images to the transmission unit 18 so that a target image having a larger image size will be displayed in a higher level. Alternatively, the determination unit 23 may transmit the target images to the transmission unit 18 so that target images containing a larger proportion of feature points will be displayed in a higher level.

In the information provision server 10D according to the present embodiment also, effects can be obtained that are the same or similar to those of the above-described information provision server 10C. With the information provision server 10D, only an image showing a scene in which a model uses the product, which is information useful for the user to purchase the product, can be transmitted to the user terminal Tu.

### Sixth Embodiment

An information provision server 10E according to a sixth embodiment will be described hereinafter. This information provision server 10E transmits a recommendation with respect to the size of a product to the user terminal Tu. Explanations of matters that are the same as or similar to those of the second embodiment are omitted below.

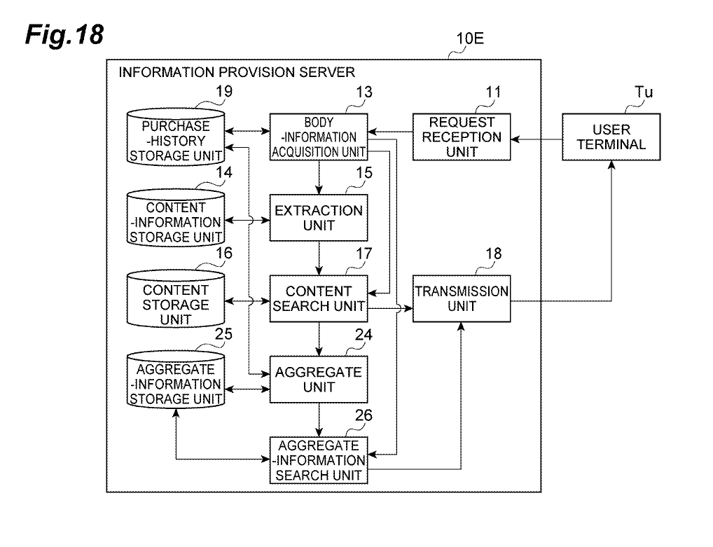

As depicted in FIG. 18, the information provision server 10E of the present embodiment further includes an aggregate unit 24, an aggregate-information storage unit 25, and an aggregate-information search unit 26. Furthermore, in the information provision server 10E of the present embodiment, the body-information acquisition unit 13 outputs a display request and user body information to the aggregate-information search unit 26. The other components are the same as those of the information provision server 10A of the second embodiment.

The aggregate unit 24 aggregates sizes of products that were purchased by a plurality of users in the past for each of physical characteristics of the users. Specifically, the aggregate unit 24 refers to purchase history information in the purchase-history storage unit 19 at a certain timing and, for a specific product, classifies the number of products that were purchased in the past by size. Subsequently, the aggregate unit 24 refers to the purchase history information, and classifies the number of products purchased for each size by physical characteristics of purchasing users to acquire aggregate information. After calculating aggregate information for one product, the aggregate unit 24 then acquires aggregate information sequentially for other products. The aggregate unit 24 stores the aggregate information thus aggregated in the aggregate-information storage unit 25.

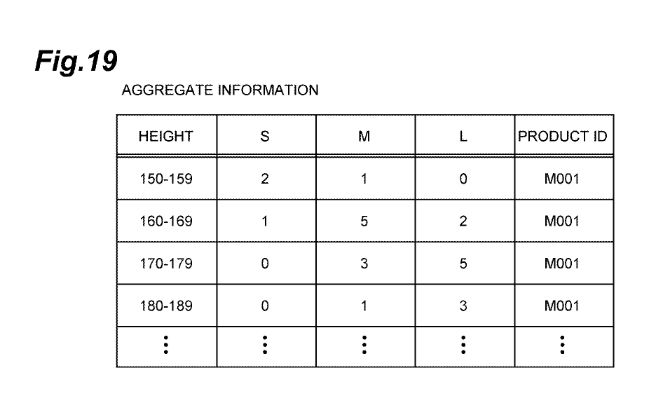

The aggregate-information storage unit 25 stores therein the aggregate information aggregated by the aggregate unit 24. FIG. 19 is a diagram illustrating an example of the aggregate information stored in the aggregate-information storage unit 25. The aggregate information depicted in FIG. 19 indicates that users of “150 cm to 159 cm” in height purchased products corresponding to the product ID “M001”, and the numbers of the products purchased were two in S size, one in M size, and zero in L size. Similarly, in the aggregate information depicted in FIG. 19, the numbers of products corresponding to the product ID “M001” that were purchased by users of “160 cm to 169 cm”, “170 cm to 179 cm”, and “180 cm to 189 cm” in height are indicated for each size.

The aggregate-information search unit 26 refers to the aggregate-information storage unit 25, and extracts aggregate information corresponding to a product ID included in the display request and the user body information. Based on the aggregate information thus extracted, the aggregate-information search unit 26 recommends the size in which users purchased the product most to the user of the user terminal Tu. For example, when the product ID included in the display request is “M001” and the height in the user body information is “180 cm”, the aggregate-information search unit 26 acquires the “L” size in which users purchased the product most as recommendation information. The aggregate-information search unit 26 outputs this recommendation information to the transmission unit 18 to present it to the user of the user terminal Tu.

In the present embodiment, the size in which users purchased the product most, the product corresponding to the product ID and the user body information, is recommended to the user of the user terminal Tu, but information to be presented to the user is not limited to such a mode. For example, the aggregate information stored in the aggregate-information storage unit 25 may be transmitted to the user terminal Tu without being processed.

In the information provision server 10E according to the present embodiment also, effects can be obtained that are the same or similar to those of the above-described information provision server 10A. In the present embodiment, based on purchase histories of other users, the size corresponding to the physical characteristics of the user is recommended, whereby the suitable size for the user can be recommended.

### Seventh Embodiment

An information provision server 10F according to a seventh embodiment will be described hereinafter. This information provision server 10F searches a products combination image on the basis of purchase histories of users on a product. Explanations of matters that are the same as or similar to those of the first embodiment are omitted below.

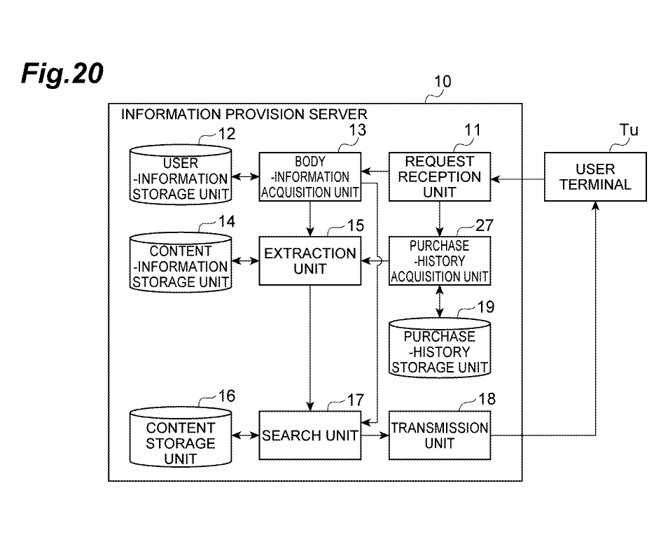

As depicted in FIG. 20, the information provision server 10F of the present embodiment further includes the purchase-history storage unit (access-history storage unit) 19 and a purchase-history acquisition unit (access-history acquisition unit) 27, and the request reception unit 11 outputs the display request from the user terminal Tu also to the purchase-history acquisition unit 27. The content-information storage unit 14 stores therein content information on a products combination image. The products combination image is an image showing a scene in which products such as accessories for a dress that are used in combination are coordinated. The products combination image is an image showing a scene in which a model wears products that are used in combined manner, and examples thereof include an image in which clothing tops and bottoms are worn in combination and an image in which clothing and shoes are worn in combination. The other components are the same as those of the information provision server 10 of the first embodiment.

The purchase-history storage unit 19 stores therein purchase history information indicating product purchase histories of users, and is the same as that described in the second embodiment.

The purchase-history acquisition unit 27 identifies a product that a user purchased in the past. When having received input of the display request from the request reception unit 11, the purchase-history acquisition unit 27 acquires a piece of purchase history information that corresponds to the user ID included in the display request from the purchase-history storage unit 19 to identify the product corresponding to the piece of purchase history information. The purchase-history acquisition unit 27 outputs the product ID of the product thus identified to the extraction unit 15.

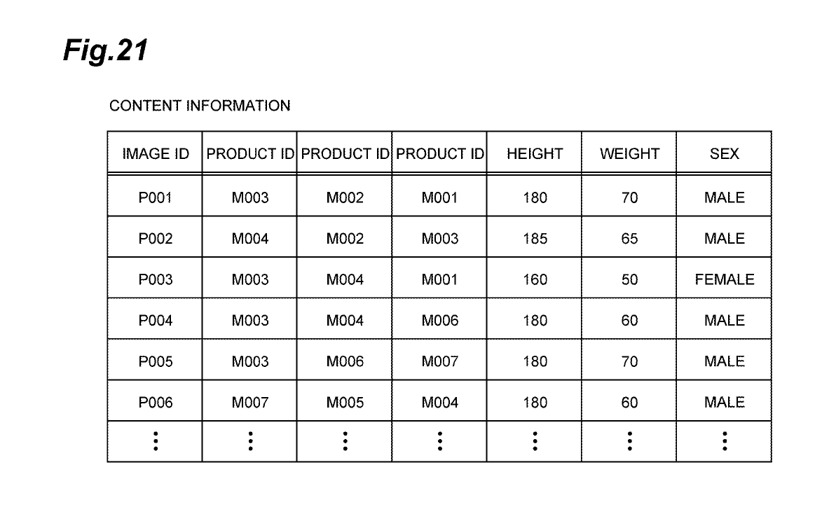

As depicted in FIG. 21, the content-information storage unit 14 stores therein product IDs of a plurality of products as content information. The content information includes an image ID, the height, weight, and sex of a model shown in the image. Explained with the example of the purchase history information depicted in FIG. 9, it is indicated in the content information of FIG. 21 that the image of image ID “P001” is an image in which “shirt A”, “necktie A”, and “pants A” are coordinated.

The extraction unit 15 extracts pieces of content information corresponding to images including the product indicated by the display request and the product identified by the purchase-history acquisition unit 27. The extraction unit 15 outputs the pieces of content information thus extracted to the search unit 17.

Among the pieces of content information extracted by the extraction unit 15, the search unit 17 searches a piece of content information corresponding to the user body information, and extracts an image indicated by the image ID of the piece of searched content information from the content storage unit 16. With reference to the examples of the user information depicted in FIG. 4, the purchase history information depicted in FIG. 9, and the content information depicted in FIG. 21, the following describes an example of image extraction performed by the information provision server 10F.

It is assumed that the display request received from the user terminal Tu includes the user ID “U001” and the product ID “M003”. In this case, the purchase-history acquisition unit 27 extracts pieces of purchase history information (pieces of purchase history information the purchase history IDs of which are “B001” and “B002”) for two records corresponding to the user ID “U001”, and identifies the products “shirt A” and “necktie A” corresponding to the pieces of purchase history information. The purchase-history acquisition unit 27 outputs the product IDs “M001” and “M002” corresponding to these products to the extraction unit 15. The body-information acquisition unit 13 outputs the height “185 (cm)” and the weight “65 (kg)” as user body information corresponding to the user ID “U001” to the search unit 17.

The extraction unit 15 extracts pieces of content information (pieces of content information the image IDs of which are “P001”, “P002”, and “P003”) for three records that include the product ID “M003” indicated by the display request and the product IDs “M001” and “M002” output by the purchase-history acquisition unit 27. The extraction unit 15 outputs the three pieces of content information thus extracted to the search unit 17.

Among the three pieces of content information input by the extraction unit 15, the search unit 17 extracts pieces of content information that include model body information in which the difference in height from the user is within a certain range. Subsequently, among the pieces of content information thus extracted, the search unit 17 extracts a piece of content information that includes model body information in which the weight is the closest to that of the user body information. For example, assuming that the certain range for height is five centimeters, the search unit 17 extracts two pieces of content information the image IDs of which are “P001” and “P002”, in which the difference from the height “185 (cm)” of the user is within five centimeters. Subsequently, the search unit 17 extracts a piece of content information the image ID of which is “P002”, which corresponds to the model body information in which the weight is the closest to the weight “65 (kg)” of the user. The search unit 17 then extracts an image associated with the image ID “P002” from the content storage unit 16.

In the information provision server 10F according to the present embodiment also, effects can be obtained that are the same or similar to those of the above-described information provision server 10. In the present embodiment, an image is extracted that corresponds to the product indicated by the display request, the product that the user purchased in the past, and the physical characteristics of the user. By transmitting such an image including the product that the user purchased in the past to the user terminal Tu, an impression when the user uses products in combination can be presented to the user, so that purchase motivation of the user can be increased.

In the foregoing, the present invention has been described in detail based on the embodiments. However, the present invention is not limited to the above-described embodiments. The present invention can be variously modified without departing from the scope thereof.

For example, the above-described embodiments may be modified as follows. In the information provision servers 10 to 10E, the search unit 17 extracts content corresponding to the physical characteristics of the user. However, the search unit 17 may extract content that corresponds to the physical characteristics of the user and also extract content that does not correspond to the physical characteristics of the user, and may transmit the respective pieces of content thus extracted to the transmission unit 18. In this case, the transmission unit 18 may transmit these pieces of content to the user terminal Tu so that the content that corresponds to the physical characteristics of the user is displayed in a higher level than the content that does not correspond to the physical characteristics of the user. This can preferentially display the content corresponding to the physical characteristics of the user.

In the information provision server 10F, the extraction unit 15 extracts an image that includes the product indicated by the display request and the product identified by the purchase-history acquisition unit 27. However, the extraction unit 15 may extract an image including the product indicated by the display request and the product identified by the purchase-history acquisition unit 27 and also extract an image that includes the product indicated by the display request but does not include the product identified by the purchase-history acquisition unit 27, and may transmit the respective images thus extracted to the transmission unit 18. In this case, the transmission unit 18 may transmit these images to the user terminal Tu so that the image including the product indicated by the display request and the product identified by the purchase-history acquisition unit 27 is displayed in a higher level than the image that includes the product indicated by the display request but does not include the product identified by the purchase-history acquisition unit 27. This can preferentially display the image of a combination of the products in which the user is interested.

In the seventh embodiment, the information provision server 10F extracts an image including the product that the user purchased in the past based on the purchase history, but the information provision server 10F may extract an image including a product that the user viewed in the past based on the browsing history of the user. In this case, the information provision server 10F needs to include a browsing-history storage unit that stores therein browsing records of the user instead of the purchase-history storage unit 19.

In the first to the seventh embodiments, the information provision servers 10 to 10F each include a plurality of storage units, but these storage units may be provided to a server other than the information provision servers 10 to 10F. Furthermore, these storage units may be integrated into one, or one storage unit may be distributed to function as a plurality of storage units.

Functions of the information provision servers of the first to the seventh embodiments may be optionally combined. For example, when the functions of the information provision servers of the first embodiment and the third embodiment are combined, the extraction unit 15 extracts images from the content-information storage unit 14 and the comment storage unit 21. This allows content to be extracted from both of an image registered in the content-information storage unit 14 by an administrator and an image posted by a model user, and the content can be presented to the user. Alternatively, when the functions of the information provision servers of the first embodiment and the fourth embodiment are combined, the extraction unit 15 extracts images from the content-information storage unit 14 and the comment storage unit 33. This allows content to be extracted from both of an image registered in the content-information storage unit 14 by an administrator and an image posted by an SNS user, and the content can be presented to the user. Alternatively, for example, the determination unit 23 described in the information provision server 10D may be provided to the information provision servers 10 to 10C, 10E, and 10F.

The timing for the determination unit 23 to determine whether the image is an image showing a scene in which the product is used is not limited to the timing described in the fifth embodiment. For example, when the information provision server 10B includes the determination unit 23, at the timing when an image is posted from a third-person terminal Tp, whether this image is an image showing a scene in which the product is used may be determined. In this case, for an image stored in the comment-information storage unit 21, the determination unit 23 may stores whether this image is an image showing a scene in which the product is used in association therewith. In this case, when the extraction unit 15 extracts the image from the comment-information storage unit 21, only images in which the product is worn may be focused as search targets. This can eliminate the necessity of performing the determination process in the determination unit 23 every time a display request for a product is received, and thus the computational load on the information provision server 10B can be reduced.

The image extraction source of the extraction unit 15 in the fourth and the fifth embodiments is not limited to the SNS server, and may be an optional external server such as a blog. The information provision servers 10B to 10D do not necessarily have to include the reward giving unit 22. Furthermore, the above-described embodiments have been described on the assumption that the display request includes one product ID, but the display request may include a plurality of product IDs. The display request may also be a query indicating a category of a product, for example.

### REFERENCE SIGNS LIST

10, 10A, 10B, 10C, 10D, 10E, 10F . . . information provision server, 11 . . . request reception unit, 12 . . . user-information storage unit, 13 . . . body-information acquisition unit, 14 . . . content-information storage unit, 15 . . . extraction unit, 16 . . . content storage unit, 17 . . . search unit, 18 . . . transmission unit, 19 . . . purchase-history storage unit (access-history storage unit), 20 . . . comment reception unit, 21 . . . comment storage unit, 22 . . . reward giving unit, 23 . . . determination unit, 24 . . . aggregate unit, 25 . . . aggregate-information storage unit, 26 . . . aggregate-information search unit, 27 . . . purchase-history acquisition unit (access-history acquisition unit), P1 . . . information provision program, P10 . . . main module, P11 . . . request reception module, P12 . . . user-information storage module, P13 . . . body-information acquisition module, P14 . . . content-information storage module, P15 . . . extraction module, P16 . . . content storage module, P17 . . . search module, P18 . . . transmission module

1. An information provision device comprising:
a reception unit that receives a display request for a product from a terminal of a user;
a body-information acquisition unit that acquires physical characteristics of the user;
a search unit that extracts, from a content storage unit that stores therein product content including information on physical characteristics, content that is related to the product indicated by the display request and indicates a state in which the product is worn by a model having physical characteristics that are the same as or similar to the physical characteristics of the user; and
a transmission unit that transmits the content extracted by the search unit to the terminal.

2. The information provision device according to claim 1, wherein the body-information acquisition unit acquires the physical characteristics of the user by referring to a purchase-history storage unit that stores therein size of a product that the user has ever purchased.

3. The information provision device according to claim 2, wherein
the content storage unit stores therein size of the product worn by the model as the physical characteristics of the model, and
the search unit extracts content indicating a product whose size is the same as the size of the product that the user has ever purchased.

4.-8. (canceled)

9. The information provision device according to claim 1, wherein the content storage unit stores therein content that was posted by another user who is different from the user,
the information provision device further comprises a first determination unit that determines whether the image posted by the other user is a wearing-scene image showing the scene in which the model wears the product, wherein
if the first determination unit determines that the image posted by the other user is not the wearing-scene image, the transmission unit does not transmit the image to the terminal.

10. The information provision device according to claim 1, wherein the content storage unit stores therein content that was posted by another user who is different from the user,
the information provision device further comprises a second determination unit that determines whether feature points of a reference image showing the product exist in the image posted by the other user at a certain proportion or more and also the feature points of the reference image contained in the image posted are dispersed within a certain area in the image posted, wherein
if the second determination unit determines that the feature points do not exist in the image posted by the other user at the certain proportion or more or if the second determination unit determines that the feature points are not dispersed within the certain area in the image posted, the transmission unit does not transmit the image to the terminal.

11. (canceled)

12. The information provision device according to claim 1 further comprising:
an aggregate unit that acquires, based on a purchase history of products purchased by a specific user, aggregate information in which sizes of the products purchased are aggregated for each physical characteristic; and
an aggregate-information search unit that presents information on size of the product to the user based on the physical characteristics of the user and the aggregate information acquired by the aggregate unit.

13. The information provision device according to claim 1 further comprising an access-history acquisition unit that refers to an access-history storage unit that stores therein an access history indicating a purchase history or a browsing history of a product to identify a product that the user has ever purchased or viewed, wherein
the search unit extracts from the content storage unit content that corresponds to both of the product indicated by the display request and the physical characteristics of the user and corresponds to the product identified by the access-history acquisition unit.

14. An information provision method comprising:
a reception step of receiving a display request for a product from a terminal of a user;
a body-information acquisition step of acquiring physical characteristics of the user;
a search step of extracting, from a content storage unit that stores therein product content including information on physical characteristics, content that is related to the product indicated by the display request and indicates a state in which the product is worn by a model having physical characteristics that are the same as or similar to the physical characteristics of the user; and
a transmission step of transmitting the content extracted at the search step to the terminal.

15.-16. (canceled)

17. The information provision device according to claim 1, wherein
the content storage unit stores content information in which an image ID for identifying an image, a product ID for identifying a product shown in the image, and information relating to physical characteristics of the model in a state in which the product is worn shown in the image, are associated,
the search unit acquires the content information including the product ID corresponding to the product indicated by the display request from the content storage unit, then compares the physical characteristics of the user and the information of physical characteristics of the model included in the content information, and thereby extracts, from the acquired content information, the content information including the information relating to the physical characteristics of the model having physical characteristics that are the same as or similar to the physical characteristics of the user, and
the transmission unit transmits an image corresponding to an image ID included in the content information extracted by the search unit to the terminal.

18. The information provision method according to claim 14, wherein
the content storage unit stores content information in which an image ID for identifying an image, a product ID for identifying a product shown in the image, and information relating to physical characteristics of the model in a state in which the product is worn shown in the image, are associated,
the search step acquires the content information including the product ID corresponding to the product indicated by the display request from the content storage unit, then by comparing the physical characteristics of the user and the information of physical characteristics of the model included in the content information, and thereby extracts, from the acquired content information, the content information including the information relating to the physical characteristics of the model having physical characteristics that are the same as or similar to the physical characteristics of the user, and
the transmission step transmits an image corresponding to an image ID included in the content information extracted by the search unit to the terminal.
